(19) United States
(12) Patent Application Publication
(10) Pub. No.: US 2019/0056057 A1
(43) Pub. Date: Feb. 21, 2019

(54) INTEGRATED BASE ASSEMBLY FOR BEAM PUMPING UNIT

(71) Applicant: Lufkin Industries, LLC, Lufkin, TX (US)

(72) Inventor: Robert Miler Jones, Diboll, TX (US)

(73) Assignee: Lufkin Industries, LLC, Lufkin, TX (US)

(21) Appl. No.: 16/105,236

(22) Filed: Aug. 20, 2018

Related U.S. Application Data
(60) Provisional application No. 62/547,572, filed on Aug. 18, 2017.

(51) Int. Cl. F16M 5/00; E21B 43/12; F16M 7/00; F16M 9/00; E02D 27/44

(52) U.S. Cl. CPC F16M 5/00; E21B 43/127; F04B 47/022; F16M 9/00; E02D 27/44; F16M 7/00

(57) ABSTRACT

A beam pumping unit includes an integrated base assembly that has a unitary pedestal, a Samson post supported by the integrated base assembly and a gear box supported by the integrated base assembly. The integrated base assembly further includes a front connection plate and a pedestal connection plate that are configured to provide a bolted support to the Samson post. The front connection plate and the pedestal connection plate can be secured to the integrated base assembly with a series of embedded tubular anchors.

### RELATED APPLICATIONS

This application claims the benefit of U.S. Provisional Patent Application Ser. No. 62/547,572 entitled “Integrated Base Assembly for Pump Jack,” filed Aug. 18, 2017, the entire disclosure of which is herein incorporated by reference.

### FIELD OF THE INVENTION

This invention relates generally to oilfield equipment, and more particularly, but not by way of limitation, to an improved base system for supporting a beam pumping unit.

### BACKGROUND

Hydrocarbons are often produced from well bores by reciprocating downhole pumps that are driven from the surface by pumping units. A pumping unit is connected to its downhole pump by a rod string. Although several types of pumping units for reciprocating rod strings are known in the art, walking beam style pumps enjoy predominant use due to their simplicity and low maintenance requirements.

In most walking beam pumping units, the walking beam is pivotally supported atop a Samson post through a saddle bearing assembly. Typically, the Samson post includes a front leg and a rear leg that are secured to one another by a connection bracket below the saddle bearing assembly. The distal end of the front leg is secured to a base assembly of the pumping unit, often with a bolted connection. The distal end of the rear leg can be secured to the pedestal or to the base assembly of the pumping unit with large bolts. The Samson post carries a significant amount of weight and is exposed to lateral forces during the operation of the pumping unit. The base assembly also carries the weight of the sub base (or pedestal) and the gearbox, crank arms and other components supported by the pedestal.

In the past, the base assembly has been shipped to the well site and placed onto a concrete pad. The base assembly typically includes a series of interconnected steel beams that are anchored to the concrete pad with bolts. The Samson post and pedestal are the connected to the top of the base assembly. Although widely adopted, the use of an independent base assembly presents added shipping and installation costs. There is, therefore, a need for an improved support system for a walking beam pumping unit. It is to these and other deficiencies in the prior art that embodiments of the present invention are directed.

### SUMMARY OF THE INVENTION

In one aspect, a beam pumping unit includes an integrated base assembly that has a unitary pedestal, a Samson post supported by the integrated base assembly, and a gear box supported by the integrated base assembly. The beam pumping unit optionally includes a front connection plate and a pedestal connection plate.

In another aspect, the invention includes a modular foundation system for a beam pumping unit. The modular foundation system includes a pad, a plurality of embedded anchors within the pad and a modular sub base connected to the pad through the embedded anchors.

In yet another aspect, the invention provides a beam pumping unit that has an integrated base assembly a Samson post supported by the integrated base assembly, and a gear box supported by the integrated base assembly. In this embodiment, the integrated base assembly includes both a unitary pedestal and a unitary front riser

### BRIEF DESCRIPTION OF THE DRAWINGS

FIG. 1 is a side view of a beam pumping unit with a first embodiment of the integrated base assembly.

FIG. 2 is a perspective view of a second embodiment of the integrated base assembly, Samson post and pedestal.

FIG. 3 is a perspective view of a third embodiment of the integrated base, sub base, and Samson post.

FIG. 4 is perspective view of an embodiment of the integrated base assembly that includes the use of a tubular bolt anchor system.

FIG. 5 is a side cross-sectional view of the tubular bolt anchor system.

FIG. 6 is a perspective view of a first embodiment of an integrated base and sub base with mounting plates and bolt windows.

FIG. 7 is a perspective view of a second embodiment of an integrated base and sub base with mounting plates and bolt windows.

FIG. 8 is perspective view of an embodiment that includes a modular base, sub base and Samson post base.

### WRITTEN DESCRIPTION

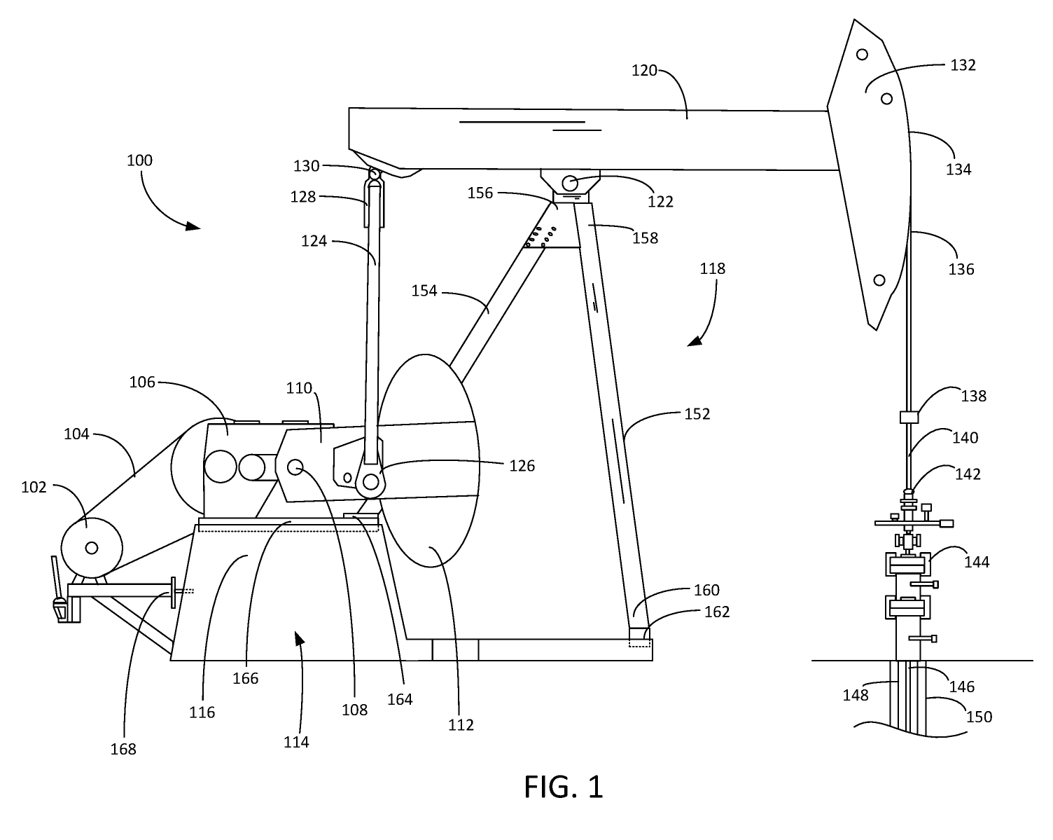

FIG. 1 shows a class 1 beam pumping unit 100. The beam pumping unit 100 is driven by a prime mover 102, typically an electric motor or internal combustion engine. The rotational power output from the prime mover 102 is transmitted by a drive belt 104 to a gearbox 106. The gearbox 106 provides low-speed, high-torque rotation of a crankshaft 108. Each end of the crankshaft 108 (only one is visible in FIG. 1) carries a crank arm 110 and a counterbalance weight 112.

The weight and forces generated by the beam pumping unit 100 are supported by an integrated base assembly 114. The integrated base assembly 114 incorporates the base, the reducer sub base (pedestal) and the concrete pad of a traditional pumping unit into a single, unitary component (designated collectively as integrated base assembly 114). In exemplary embodiments, the integrated base assembly 114 is formed as a precast concrete body that is designed and configured to distribute and transfer the weight and dynamic loading forces produced by the beam pumping unit 100. The integrated base assembly 114 may be constructed using post-tensioning, pre-tensioning, simple rebar reinforcement or a combination of these concrete casting and reinforcing methods. In each case, the integrated base assembly 114 includes a series of interconnected or separated structural reinforcements that allow the pad to accommodate and withstand the cyclic tensile load forces that are produced by the beam pumping unit 100 during operation.

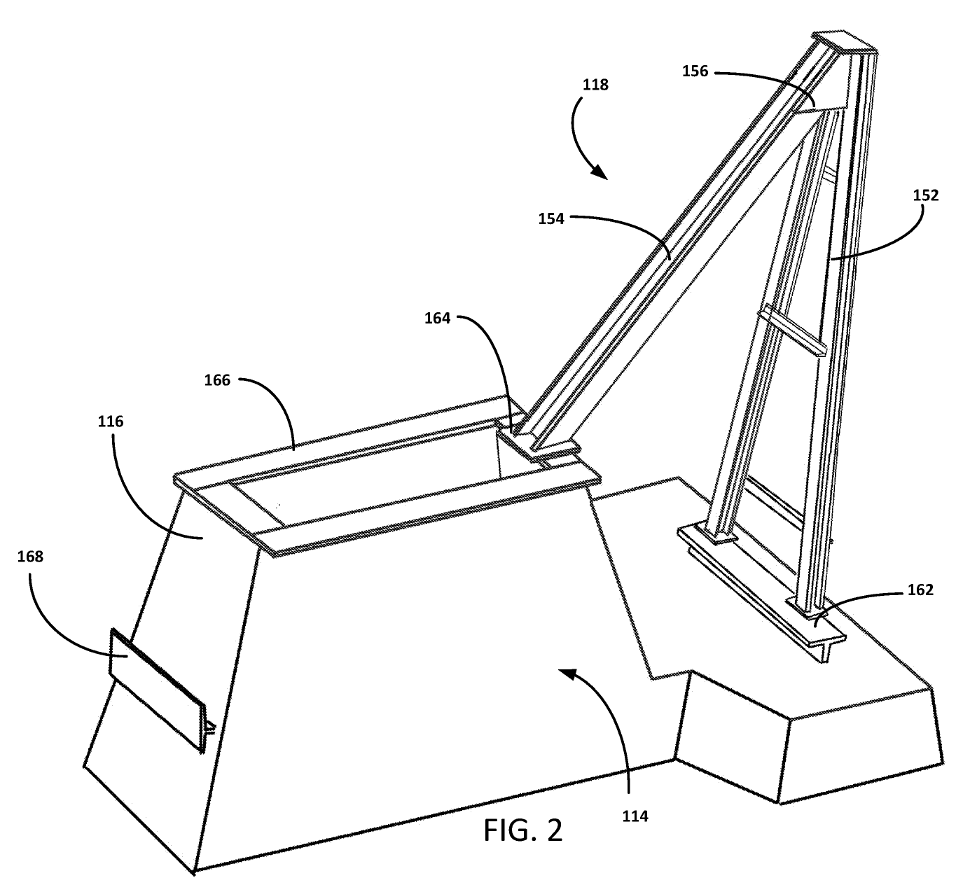

In the embodiment depicted in FIGS. 1 and 2, the integrated base assembly 114 includes an elevated pedestal 116 that is formed as a unitary portion of the integrated base assembly 114. The pedestal 116 includes components referred to in some applications as the reducer sub base. The pedestal 116 portion of the integrated base assembly 114 provides clearance for the crank arms 110 and counterbalance weights 112 to rotate. The integrated base assembly 114 also supports a Samson post 118. The top of the Samson post 118 acts as a fulcrum that pivotally supports a walking beam 120 via a saddle bearing assembly 122, commonly referred to as a center bearing assembly.

Each crank arm 110 is pivotally connected to a pitman arm 124 by a crank pin bearing assembly 126. The two pitman arms 124 are connected to an equalizer bar 128, and the equalizer bar 128 is pivotally connected to the rear end of the walking beam 120 by an equalizer bearing assembly 130. A horse head 132 with an arcuate forward face 134 is mounted to the forward end of the walking beam 120. The face 134 of the horse head 132 interfaces with a flexible wire rope bridle 136. At its lower end, the bridle 136 terminates with a carrier bar 138, upon which a polished rod 140 is suspended.

The polished rod 140 extends through a packing gland or stuffing box 142 on a wellhead 144. A rod string 146 of sucker rods hangs from the polished rod 140 within a tubing string 148 located within the well casing 150. The rod string is connected to the plunger of a subsurface pump (not illustrated). In a reciprocating cycle of the beam pumping unit 100, well fluids are lifted within the tubing string 148 during the rod string 146 upstroke.

The Samson post 118 includes a front leg 152, a rear leg 154 and a connection bracket 156. In some embodiments, the connection bracket 156 is rigidly affixed to an upper end 158 of the front leg 152. The connection bracket 156 can be secured to the front leg 152 with a welded or bolted connection. A lower end 160 of the front leg 152 is rigidly secured with a bolted connection to the integrated base assembly 114 with a front connection plate 162. In this way, the front leg 152 and connection bracket 156 are held in a fixed geometric relationship with the integrated base assembly 114. The rear leg 154 includes a proximal end that is retained by the connection bracket 156. The rear leg 154 includes a distal end that terminates in a rear foot 164. The rear foot 164 is attached to the distal end of the rear leg 154 at a fixed angle with a welded or bolted connection.

The rear foot 164 and gearbox 106 are secured to the pedestal 116 with a pedestal connection plate 166. The integrated base assembly 114 optionally includes a rear connection plate 168. The rear connection plate 168 can be used to support the prime mover 102 and other drive elements between the prime mover 102 and the gearbox 106.

The front connection plate 162, the pedestal connection plate 166 and the rear connection plate 168 are each constructed as rigid, durable, high-strength metal frames that are partially embedded within the integrated base assembly 114 as it is formed. In this way, the front connection plate 162, the pedestal connection plate 166 and the rear connection plate 168 are produced as integral parts of the integrated base assembly 114. The embedded portions of the front connection plate 162, the pedestal connection plate 166 and the rear connection plate 168 are optimally connected to the internal structural reinforcements within the integrated base assembly 114.

During manufacture, the structural reinforcements are assembled and placed into a concrete form (not shown). The front connection plate 162, the pedestal connection plate 166 and the rear connection plate 168 are then connected to the structural reinforcements such that the exposed portions of the front connection plate 162, the pedestal connection plate 166 and the rear connection plate 168 extend above or beyond the concrete form. Next, an appropriate, high-strength concrete mixture is poured into the form to cover the embedded portions of the front connection plate 162, the pedestal connection plate 166 and the rear connection plate 168. Depending on the type of structural reinforcements used and whether the integrated base assembly 114 is pre-tensioned or post-tensioned, additional steps may be required to complete the production of the integrated base assembly 114. When fully and properly tensioned, the integrated base assembly 114 can be shipped to the well site and placed on a leveled landing surface. The Samson post 118, gearbox 106 and other components of the pumping jack 100 can then be secured to the exposed portions of the integrated base assembly 114.

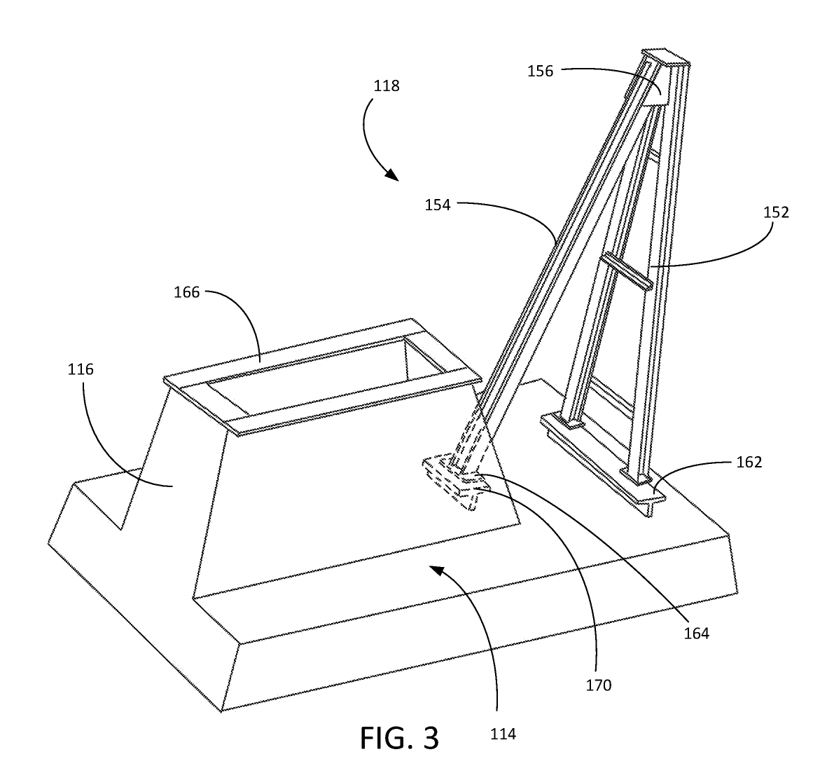

Turning to FIG. 3, shown therein is an embodiment in which the integrated base assembly 114 includes an optional Samson foot connection plate 170. Like the front connection plate 162, the pedestal connection plate 166 and the rear connection plate 168, the Samson foot connection plate 170 is constructed as a metal frame that is partially embedded within the concrete of the integrated base assembly 114 and connected to the internal concrete reinforcement members. The Samson foot connection plate 170 is adapted for a bolted connection to the foot 164 of the Samson post 118. Each of the front connection plate 162, the pedestal connection plate 166, the rear connection plate 168 and the Samson foot connection plate 170 may be configured as an I-beam with exposed flanges to facilitate a bolted connection to the various components of the beam pumping unit 100.

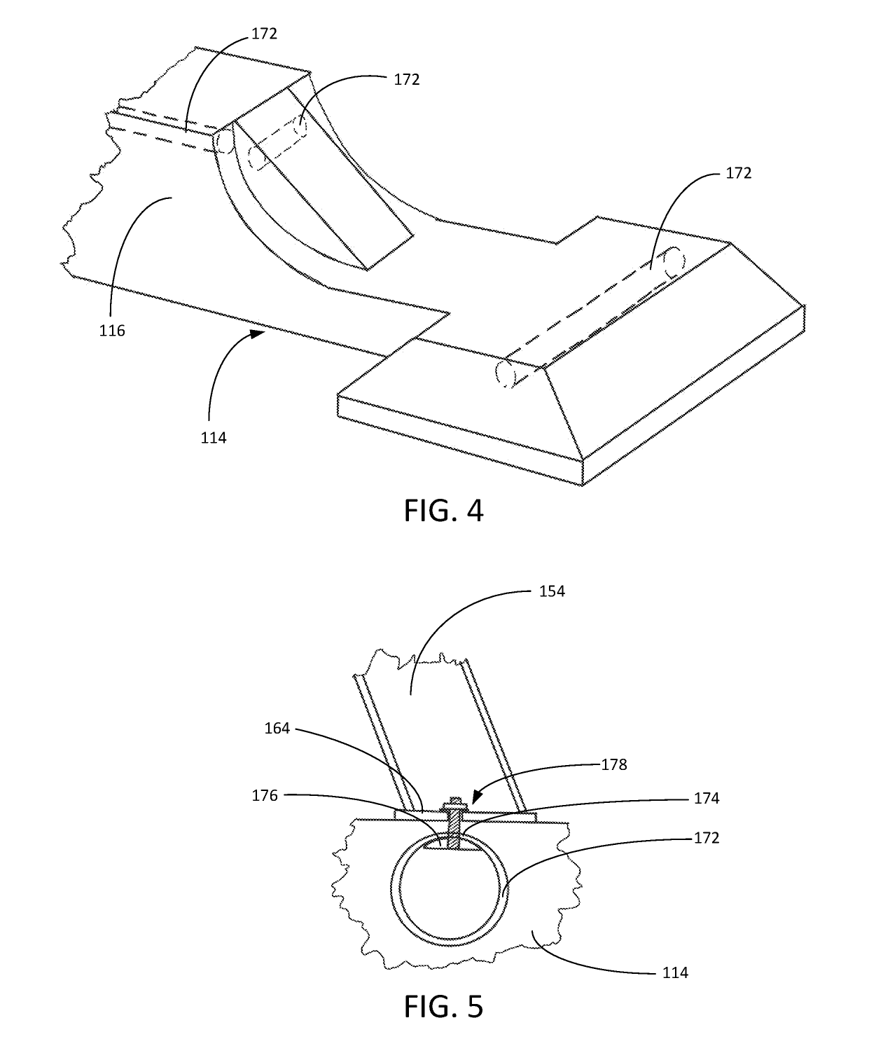

Turning to FIG. 4, shown therein is a partial perspective view of the integrated base assembly 114 constructed in accordance with an additional embodiment. As depicted in FIG. 4, the integrated base assembly 114 includes a unitary pedestal 116 and one or more tubular anchors 172 embedded within the integrated base assembly 114. The tubular anchors 172 provide an alternative method for securing the various components of the beam pumping unit 100 to the integrated base assembly 114. As more clearly shown in the partial cross-sectional and close-up view in FIG. 5, each tubular anchor 172 includes a rigid tubular member embedded within the integrated base assembly 114. Each tubular anchor 172 includes a plurality of slots 174 that are sized to accommodate a bolt lock 176. During installation, the bolt lock 176 and connected bolt 178 can be inserted through the slot 174 and rotated into position in which the bolt 178 and bolt lock 176 cannot be withdrawn through the slot 174. As shown in FIG. 5, the rear foot 164 of the Samson post 118 can be bolted to the integrated base assembly 114 using the tubular anchor 172, bolt 178 and bolt lock 176.

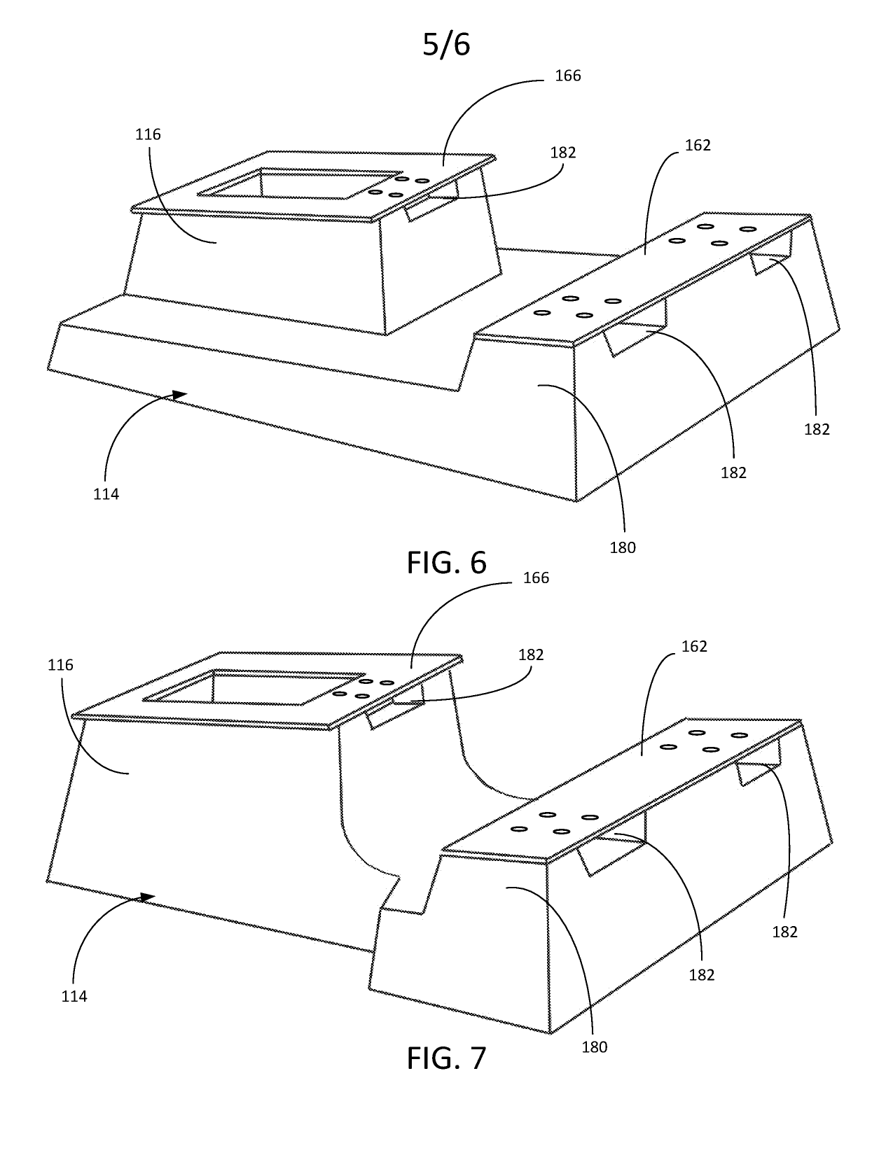

Turning to FIGS. 6 and 7, shown there are perspective views of alternative embodiments of the integrated base assembly 114. In these embodiments, the integrated base assembly 114 includes an integrated pedestal 116 and an integrated front riser 180. The front connection plate 162 and pedestal connection plate 166 are secured to the pedestal 116 and front riser 180, respectively. The front connection plate 162 and pedestal connection plate 166 can be secured with a bolted connection to embedded tubular anchors 172. Alternatively, the front connection plate 162 and pedestal connection plate 166 can configured with portions that are embedded within the integrated base assembly 114 when the concrete is poured and cured. In the embodiments depicted in FIGS. 5 and 6, the pedestal 116 and front riser 180 each includes one or more access windows 182 that provide access to bolts extending the front connection plate 162 and pedestal connection plate 166 to facilitate a bolted connection to the Samson post 118.

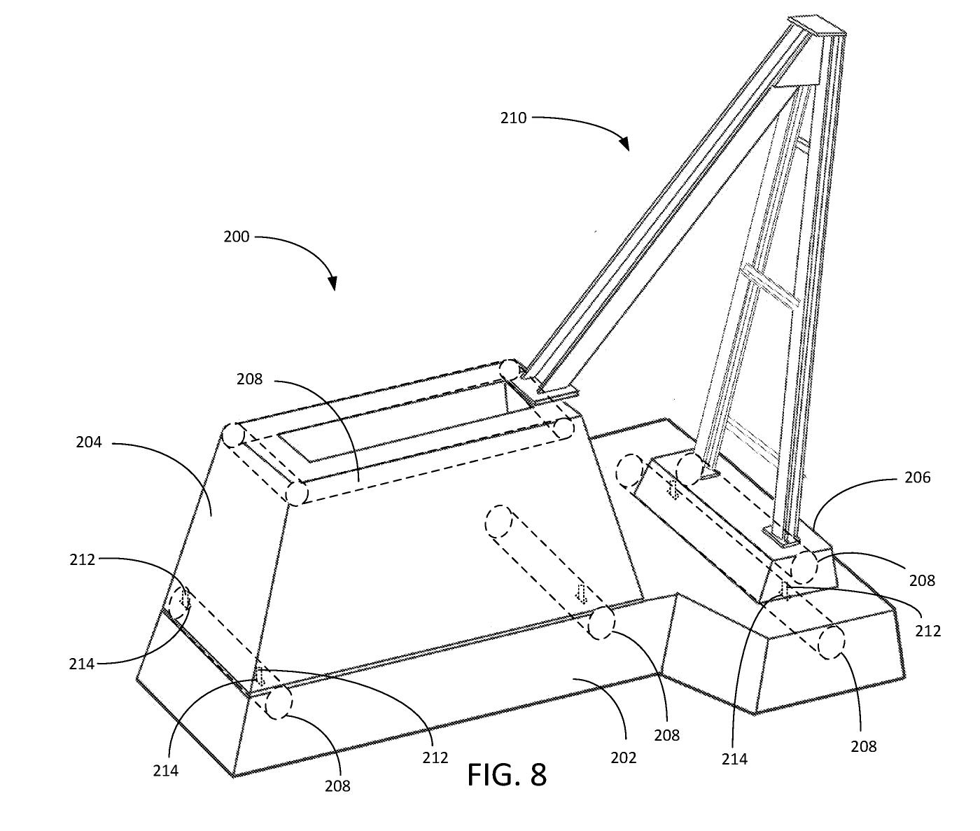

Turning to FIG. 8, shown therein is a modular foundation system 200 that includes a precast concrete pad 202, a modular sub base 204, and a modular Samson base 206. The modular foundation system 200 includes one or more tubular anchors 208 that are embedded within the pad 202, modular sub base 204 and modular Samson base 206 as described above with reference to FIGS. 5 and 6. The modular sub base 204 and modular Samson base 206 may include integral fasteners 212 that are configured to engage and lock within corresponding receivers 214 in the tubular anchors 208 within the pad 202. This allows the modular sub base 204 and modular Samson base 206 to be easily secured to the concrete pad 202 with the tubular anchors 208. Similarly, a Samson post 210 can be fixed to the modular sub base 204 and modular Samson base 206 using additional tubular anchors 208. In this way, modular foundation system 200 can be rapidly assembled using a series of tubular anchors 208 and mating fasteners 212 within the modular sub base 204, modular Samson base 206 and Samson post 210.

Thus, the various embodiments of the integrated base assembly 114 disclosed herein present an efficient, cost-effective solution for supporting the beam pumping unit 100. It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A beam pumping unit comprising:
an integrated base assembly, wherein the integrated base assembly comprises a unitary pedestal;
a Samson post supported by the integrated base assembly; and
a gear box supported by the integrated base assembly.

2. The beam pumping unit of claim 1, wherein the integrated base assembly further comprises:
a front connection plate; and
a pedestal connection plate.

3. The beam pumping unit of claim 2, wherein the integrated base assembly further comprises a rear connection plate.

4. The beam pumping unit of claim 2, wherein the integrated base assembly further comprises a plurality of embedded tubular anchors and wherein the front connection plate and the pedestal connection plate are each secured to a separate one of the plurality of embedded tubular anchors.

5. The beam pumping unit of claim 4, wherein the integrated base assembly further includes one or more access windows to facilitate a bolted connection to one or more of the front connection plate and the pedestal connection plate.

6. The beam pumping unit of claim 4, wherein each of the embedded tubular anchors includes a slot that is configured to receive a bolt lock.

7. The beam pumping unit of claim 1, wherein the integrated base assembly further comprises a unitary front riser.

8. A beam pumping unit comprising:
an integrated base assembly, wherein the integrated base assembly comprises:
a unitary pedestal; and
a unitary front riser;
a Samson post supported by the integrated base assembly; and
a gear box supported by the integrated base assembly.

9. The beam pumping unit of claim 8, wherein the integrated base assembly further comprises:
a front connection plate connected to the front riser; and
a pedestal connection plate connected to the pedestal.

10. The beam pumping unit of claim 9, wherein the integrated base assembly further comprises a rear connection plate.

11. The beam pumping unit of claim 9, wherein the integrated base assembly further comprises a plurality of embedded tubular anchors and wherein the front connection plate and the pedestal connection plate are each secured to a separate one of the plurality of embedded tubular anchors.

12. The beam pumping unit of claim 11, wherein the integrated base assembly further includes one or more access windows to facilitate a bolted connection to one or more of the front connection plate and the pedestal connection plate.

13. The beam pumping unit of claim 12, wherein each of the embedded tubular anchors includes a slot that is configured to receive a bolt lock.

14. A modular foundation system for a beam pumping unit, the modular foundation system comprising:
a pad;
a plurality of embedded anchors within the pad; and
a modular sub base connected to the pad through the embedded anchors.

15. The modular foundation system of claim 14, wherein the pad is a precast concrete pad.

16. The modular foundation system of claim 15, further comprising a modular Samson base connected to the pad through the embedded anchors.

17. The modular foundation system of claim 16, wherein the modular sub base includes a plurality of integral fasteners.

18. The modular foundation system of claim 17, wherein one or more of the plurality of embedded anchors includes a plurality of receivers and wherein each of the plurality of receivers is configured to engage in a locking relationship with a corresponding one of the plurality of integral fasteners.

19. The modular foundation system of claim 18, wherein the modular Samson base includes an embedded anchor configured to engage a Samson post in a bolted connection.

20. The modular foundation system of claim 19, wherein the modular sub base includes an embedded anchor configured to engage a Samson post in a bolted connection.
